(19) United States
(12) Patent Application Publication
(10) Pub. No.: US 2010/0251098 A1
(43) Pub. Date: Sep. 30, 2010

(54) Delivering Client Content on a Webpage

(75) Inventors: Dipinder Singh Rekhi, Redmond, WA (US); Jeffrey E. Steinbok, Redmond, WA (US); Greg S. Friedman, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/413,918

(22) Filed: Mar. 30, 2009

(51) Int. Cl. G06F 17/00

(52) U.S. Cl. 715/235; 715/234

(57) ABSTRACT

Techniques are described to deliver client content on a webpage. In implementations, client content is retrieved to be presented in a webpage to be served to a client. A presentation template is also retrieved. The presentation template includes at least one server-side tag configured to define a presentation of the client content in the webpage. The client content is then integrated with the presentation template by the server as defined by the at least one tag to generate the webpage.

### BACKGROUND

Many websites allow clients to create personalized webpages to share content with other users of the website. For example, social networking websites often allow clients to create a personal webpage to share content such as photographs, videos, text, blogs, links, gadgets, and so forth with other members of the social network.

Typically, these websites provide the client with some ability to customize the client's webpage. For example, a typical social networking website may allow a client to select a theme and layout for the client's webpage from among a predetermined number of themes and layouts. The user's content is presented within the structure dictated by the theme and layout selected for the webpage by the user.

### SUMMARY

Techniques are described to deliver client content on a webpage. In implementations, client content is retrieved to be presented in a webpage to be served to a client. A presentation template is also retrieved. The presentation template includes at least one server-side tag configured to define a presentation of the client content in the webpage. The client content is then integrated with the presentation template by the server as defined by the at least one tag to generate the webpage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to implement server-side techniques to deliver client content on webpages.

FIG. 2 is an illustration depicting integration of client content into a presentation by the server of FIG. 1.

FIG. 3 is a flow diagram depicting a procedure in an example implementation in which server-side techniques are used to deliver client content on a webpage by a server such as the server of FIG. 1.

FIGS. 4 and 5 are illustrations example displays of webpages generated by integrating client content into a presentation as shown in FIG. 3

### DETAILED DESCRIPTION

Overview

Techniques are described to deliver content, in particular, client content such as photographs, text, videos, blogs, and so forth, on a webpage. The techniques allow the presentation of the content and/or the content itself to be customized (e.g., by modifying themes, layouts, applying digital imaging effects to client photographs, and so forth) on the server side to make the webpage aesthetically pleasing to clients who access the webpage. The techniques also allow the client for which the webpage is created to easily switch between presentations, e.g., colors, styles, themes, layouts, customizations to client content, and so forth.

Webpages may be customized on the client side by using hypertext markup language (HTML) structuring and cascading style sheet (CSS) styling by the a client's browser. For example, a website, such as a social networking website, may allow a client to select a layout for a webpage from among a number of layouts that have HTML structures that have been previously defined. The client may also be permitted to select a theme specified using CSS.

During their design, the layouts are typically represented using a language that is more abstract than HTML. For example, a layout may be represented using an extensible markup language (XML) to include a desired number of columns having a predetermined width. The XML of the layout may then be converted into HTML, resulting in a layout in which the client content is to be presented that is to some extent rigid.

The techniques described herein allow flexibility in the design of webpages by implementing a meta-language comprised of hypertext markup language (HTML) configured to implement server-side tags that represent the client content. An engine executed by the server converts the meta-language into HTML to insert the layout within the webpage. The engine may also process client content on the server, e.g., when specified by the designer via a server-side tag of the meta-language.

In implementations, the engine integrates client content to be presented in a webpage with a presentation template created using the meta-language. The presentation template includes at least one server-side tag configured to define a presentation of the client content in the webpage. The engine may also generate instance data that defines the integration of the client content into the presentation template to configure hypertext markup language (HTML) describing the webpage.

In the following discussion, an example environment is first described that is operable to generate a user interface. Examples of user interfaces are then described that may be employed in the illustrated environment, as well as in other environments without departing from the spirit and scope thereof.

Example Environment

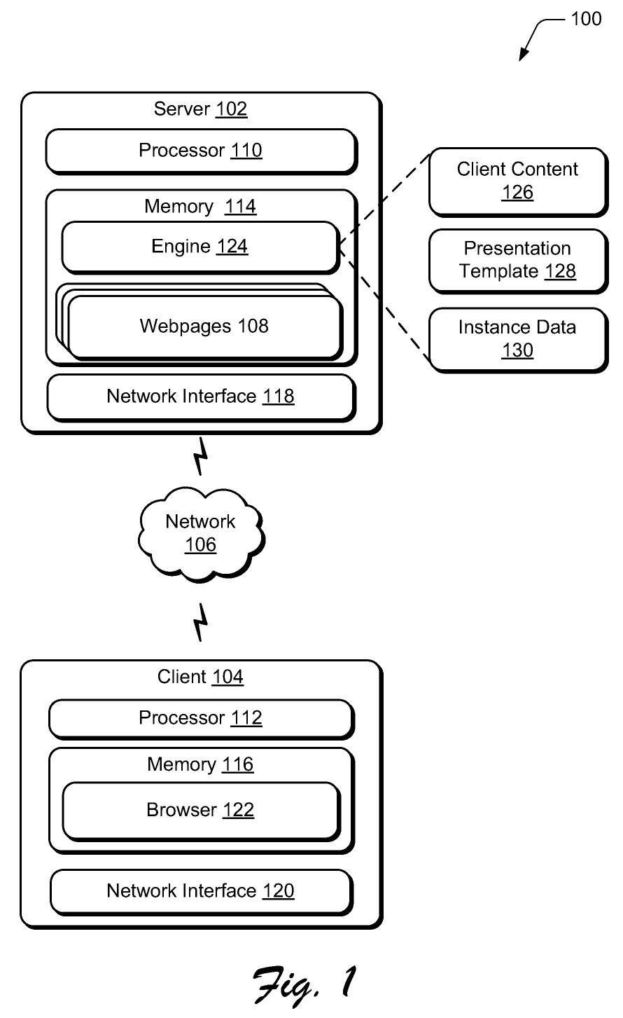

FIG. 1 illustrates an environment 100 in an example implementation that is operable to implement server-side techniques to deliver client content on a webpage. The illustrated environment 100 includes a server 102 and one or more clients 104 that communicate via a network 106. The server 102 may be configured in a variety of ways. For example, the server 102 may be configured as a server computer that is capable of communicating over a wired or wireless network 106. In one implementation, the server 102 may be an application service provider (ASP) that provides access to webpages 108 to clients 104 via the Internet. For example, server may be the server of a social networking website that allows clients 104 (one client is illustrated) to configure webpages 108 to display a variety of content.

The clients 104 may also be configured in a variety of ways. For example, one or more of the clients 104 may be configured as a computer such as a desktop or laptop computer that is capable of communicating over a wired or wireless network. The clients 104 may also be configured as a mobile connected device such as a personal digital assistant, a smart phone, or a cell phone that is capable of communicating over a wireless network; an entertainment appliance; a set-top box communicatively coupled to a display device; a game console, and so forth. Thus, the clients 104 may range from full resource devices with substantial memory and processor resources (e.g., a personal computer, a game console, etc.) to comparatively low-resource devices with limited memory and/or processing resources (e.g., a cell phone, a set top box, etc.). The clients 104 may also relate to a user such as a person and/or entity that operate such devices. Thus, clients 104 may describe logical clients that include users (e.g., persons or entities), software, and/or devices.

The network 106 may assume a wide variety of configurations. For example, the network 106 may include the Internet, a wide area network (WAN), a local area network (LAN), a wireless network (e.g., a WIFI (IEEE 802.11) network), a cellular telephone network, a public telephone network, an extranet, an intranet, and so on. Further, although a single network 106 is shown, the network 106 may be configured to include multiple networks. For instance, a desktop or laptop computer may connect to the Internet via a local area network so that the computer's web browser may access a webpage provided by a website within the World Wide Web (WWW). Similarly, a mobile browser in a smart phone may access a webpage within a corporate intranet via a cellular telephone network. A wide variety of other instances are also contemplated.

In FIG. 1, the server 102 and the client 104 are illustrated as including a respective processor 110, 112; a respective memory 114, 116; and a respective network interface 118, 120. In the following discussion, elements of the server 102 are described with reference to FIG. 1. Respective elements and/or reference numbers related of the client 104 are shown in parentheses. Where appropriate, elements of the client 104 are described separately.

The processor 110 (112) provides processing functionality for the server 102 (client 104) and may include any number of processors, micro-controllers, or other processing systems and resident or external memory for storing data and other information accessed or generated by the server 102 (client 104). The processor 110 (112) may execute one or more software programs that implement techniques described herein. The processor 110 (112) is not limited by the materials from which it is formed or the processing mechanisms employed therein, and as such, may be implemented via semiconductors and/or transistors (e.g., electronic integrated circuits (ICs)), and so forth.

The memory 114 (116) is an example of a tangible computer-readable media that provides storage functionality to store various data associated with the operation of the server 102 (client 104), such as the software program and code segments mentioned above, or other data to instruct the processor 110 (112) and other elements of the server 102 (client 104) to perform the steps described herein. Although a single memory 114 (116) is shown, a wide variety of types and combinations of memory may be employed. The memory 114 (116) may be integral with the processor 110 (112), stand-alone memory, or a combination of both. The memory may include, for example, removable and non-removable memory elements such as RAM, ROM, Flash (e.g., SD Card, mini-SD card, micro-SD Card), magnetic, optical, USB memory devices, and so forth. In embodiments of the client 104, the memory 116 may include removable ICC (Integrated Circuit Card) memory such as provided by SIM (Subscriber Identity Module) cards, USIM (Universal Subscriber Identity Module) cards, UICC (Universal Integrated Circuit Cards), and so on.

The network interface 118 (120) provides functionality to enable the server 102 (client 104) to communicate with one or more networks, such as network 106 of FIG. 1. In various implementations, the network interface 118 (120) may include a variety of components such as modems, routers, wireless access points, cellular telephone transceivers, and so forth, and any associated software employed by these components, e.g., drivers, configuration software, and so on. In FIG. 1, the network interface 118 (120) is illustrated as being an internal component of the server 102 (client 104). However, in some implementations, one or more components of the network interface 118 (120) may be external components coupled to the server 102 (client 104) via a wired or wireless connection.

The client 104 is illustrated as including a browser 122, which may be implemented as a software application stored in memory 116 and executed by the processor 112 of the client 104. The browser 122 allows the client to display and interact with webpages such as the webpages 108 provided by the server 102. The browser 122 may be configured in a variety of ways. For example, the browser 122 may be configured as a web browser suitable for use by a full resource device with substantial memory and processor resources, e.g., a personal computer, a laptop computer, a game console, and so on. In other implementations, the browser 122 may be configured as a mobile browser suitable for use by a low-resource device with limited memory and/or processing resources (e.g., a PDA, a smart phone, a cell phone, and so on). Such mobile browsers may be configured to conserve memory and processor resources, but may offer fewer browser functions than web browsers.

As illustrated in FIG. 1, the server 102 may include a content integration engine 124, which may be implemented as a software application stored in memory 114 and executed by the processor 110 of the server 102. The content integration engine 124 is representative of functionality to integrate client content 126 to be presented in a webpage 108 with a presentation template 128. The content integration engine 124 may also provide functionality to generate instance data 130 that defines the integration of the client content 126 into the presentation template 128 to configure hypertext markup language (HTML) describing the webpage 108.

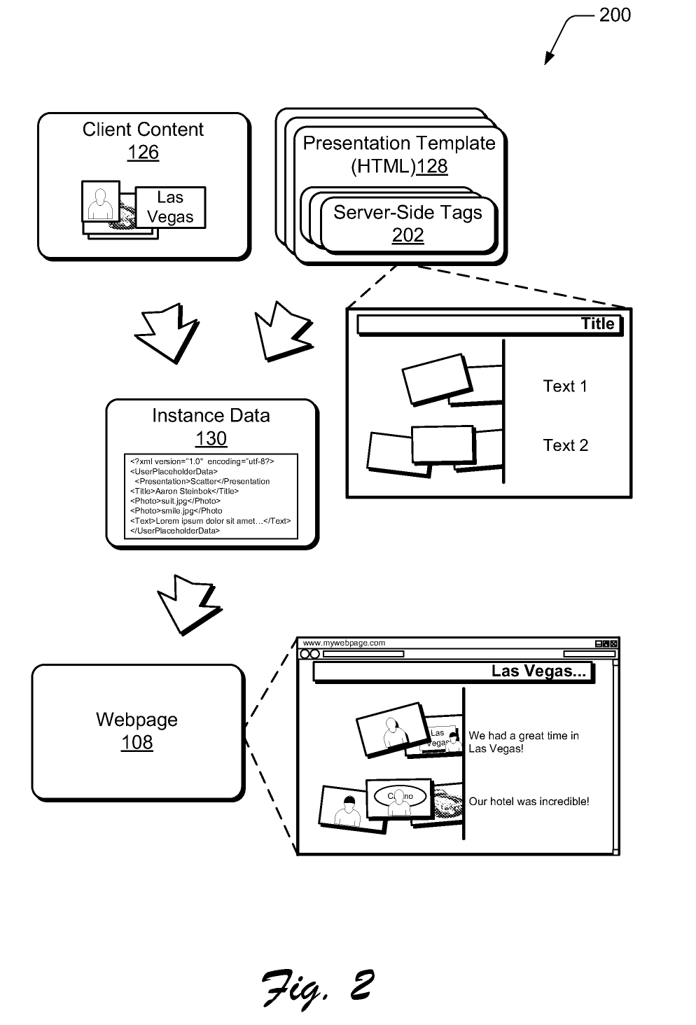

FIG. 2 illustrates integration 200 of client content 126 into a presentation template 128 by the content integration engine 124 (FIG. 1). Client content 126 may include a variety of data and information such as photographs, text, videos, audio, drawings, graphics, blogs, links, and so forth. In an implementation, client content 126 is retrieved from the client 104 by the server 102. For example, client content 126 may be stored in memory 116 of the client and provided to the server 102 by the client's browser 122 so that the content 126 may be integrated with the webpage 108. Client content 126 may also be retrieved from sources other than the client 104. For example, client content 126 may be retrieved from websites within the World Wide Web (WWW) through a network 106, such as the Internet, from another client 104 of the server 102, and so forth. In embodiments, client content 126 may be stored in memory 114 of the server 104, either temporarily or persistently, for integration with the presentation template 128 to generate the webpage 108.

The presentation template 128 is generated using a meta-language comprised of hypertext markup language (HTML) configured to implement server-side tags 202 that represent the client content 126. In an implementation, the presentation template 128 may comprise a presentation XML and presentation resources. The presentation XML specifies the manner in which the client content 126 is presented in the webpage 108. For example, the presentation XML may specify a visual theme for presentation of the client content 126, a behavior for the client content 126, and so forth. In embodiments, the presentation XML may include meta-language elements including one or more server-side tags 202, as well as HTML and CSS elements. An example presentation XML that contains both meta-language and CSS elements is shown below:

```
<presentation>
  <author>drek</author>
  <name>Sample presentatnion</name>
  <inclineStyleSheet>
    <![CDATA[
      body { margin: 0; padding: 0px;}
      #container {width:750px;margin:auto;}
      #title {color:white;font:bold 35px “Segoe UI” }
    ]]>
  </inclineStyleSheet>
  <canvasMarkup>
    <!{CDATA{
      <div id=“container”>
        <div id=“title”>Absolute:Title /></div>
        <div style=“position:absolute;top:40px;left:190px;”>
          <Absolute:Photo Frame=”frame.jpg, 144” Rotate=“−5” />
          <Absolute:Text />
        </div>
      </div>
    ]]>
  </canvasMarkup>
</presentation>
```

Other examples are possible.

Presentation resources may include images, CSS, scripts, and so forth that are related to the presentation template 128. For example, presentation resources may include a theme background image, CSS style sheets, and so forth. In embodiments, the presentation resources are independent of the client content 126.

Server-side tags 202 allow client content 126 (e.g., photographs, text, video, audio, and so forth) to be inserted into the HTML of the webpage 108. For example, each server-side tag 202 may translate to one or more elements of the HTML describing the webpage 108. Additionally, server-side tags 202 may be used to control the style and appearance to the client content 126 (e.g., in place or in addition to the use of CSS).

Server-side tags 202 may be configured to furnish functionality to the presentation templates 128 that is not furnished using HTML and CSS alone, such as digital image transformations, gradient shadows, rotation, framing, masking, and so forth. It is contemplated that server-side tags 202 implemented by the meta-language used to generate the presentation templates 128 may have a variety of formats and may implement a range of functionality.

In embodiments, server-side tags 202 may include a tag type configured to specify a content type represented by the tag 202 and at least one tag attribute configured to specify one or more attributes of the content. For example, in an embodiment wherein a storytelling webpage 108 is generated, example server-side tags 202 implemented in the HTML of a presentation template 128 may include server-side tags 202 have tag types identifying the tags as title tags, text tags, photo tags, and so forth. The title tag (e.g., “<Absolut:Title />”) emits a plain text title of the story of the storytelling webpage 108. Similarly, a text tag (e.g., “<Absolut:Text />”) emits text. The text may contain inline markup, e.g., bold, italic, anchor tags, and so on. This tag may also provide a degree of control to the client with respect to the manner in which the text is presented by the webpage 108.

The photo tag (e.g., “<Absolut:Photo [ImageStyle=”image CSS”] [Frame=“width,height”| Frame=“image, containerWidth,containerHeight, offsetX, offset, photoWidth, photoHeight”] [Shadow=“shadowWidth,rgb (R,G,B), opacity] [Rotate=“angle”] [GrayScale=“true/false”]/>”) emits the HTML (e.g., an HTML <img> element) to insert a photograph in the webpage 108. However, in some implementations, the photo tag may be configured so that it does not emit an HTML <img> element depending on the values of the attributes specified. For example, the photo tag may be configured so that some effects may not be implemented using CSS on <img> elements. Instead, the photo tag may cause vector graphics to be inserted using a suitable language such as Canvas Object or VML (Vector Markup Language).

In some implementations, processing of client content such as a photograph may be implemented on the client side in addition the processing performed on the server side. For example, framing and grayscale effects may be processed via transformations on the server side, while shadow and rotation effects may be processed via transformations on the client side.

Framing may be implemented on the server side in different ways. In one embodiment, a presentation template 128 may specify the width and height of a container for client content 126 such as a photograph to be inserted in a webpage 108. The photograph may be resized, cropped and centered so that it fits within the specified container. In this manner, the layout of the webpage 108 may be controlled, regardless of the original size of the photograph without distortion of the photograph. In another embodiment, a frame image, dimensions of the frame image, dimensions of a container that contains the photograph and an offset of the container with respect to the photograph may be specified to achieve effects such as POLAROID (Polaroid Minnetonka, Minn.) framing (framing that resembles a POLAROID photograph), wooden framing (framing that resembles a wooden picture frame, and so forth.

Shadowing and rotation may be applied to client content 126 such as the photograph described above via client-side processing of the photograph after the server-side transformations (e.g., framing, grayscale, and so on), if any, have been applied. For example, on the client side, a photograph may be inserted in a canvas object or VML object. A shadow may then be added or the photograph rotated using a corresponding vector language. An inline element is thus generated that contains both the photograph and the shadow/rotation.

Instance data 130 may be generated to define the integration of the client content 126 into the presentation template 128 to configure hypertext markup language (HTML) describing the webpage 108. In implementations, the instance data 130 specifies how the client content 126 is tied to the presentation template 128. For example, in the storytelling webpage embodiment described above, the instance data 130 may be created for each story. In embodiments, the instance data 130 may contain information about the selected presentation template 128 to be used and the client content 126 (e.g., the photographs, text, video, audio, and so forth) is to be inserted into the placeholders created by the server-side tags 202 within the presentation template 128. The instance data 130 may also contain any other automatically generated supporting data that may be related to an instance of the client content 126 and presentation template 128. In implementations, the instance data 130 may be cleared and regenerated if the client content 126, presentation template 128, or presentation of the client content 126 within the presentation template 128 is changed.

Generally, any of the functions described herein may be implemented using software, firmware, hardware (e.g., fixed logic circuitry), manual processing, or a combination of these implementations. The terms “module”, “engine,” and “functionality” as used herein generally represent software, firmware, hardware or a combination thereof. In the case of a software implementation, for instance, a module or engine represents executable instructions that perform specified tasks when executed on a processor, such as the processors 110 & 112 of the server 102 and client 104 of FIG. 1. The program code may be stored in one or more tangible computer readable media, an example of which is the memories 114 & 116 of the server 102 and client 104 of FIG. 1. The features of the techniques described below are platform-independent, meaning that the techniques may be implemented on a variety of commercial computing platforms having a variety of processors.

Example Procedures

The following discussion describes techniques for delivering client data on a webpage that may be implemented utilizing the previously described systems and devices. Aspects of each of the procedures may be implemented in hardware, firmware, software or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and/or other example embodiments.

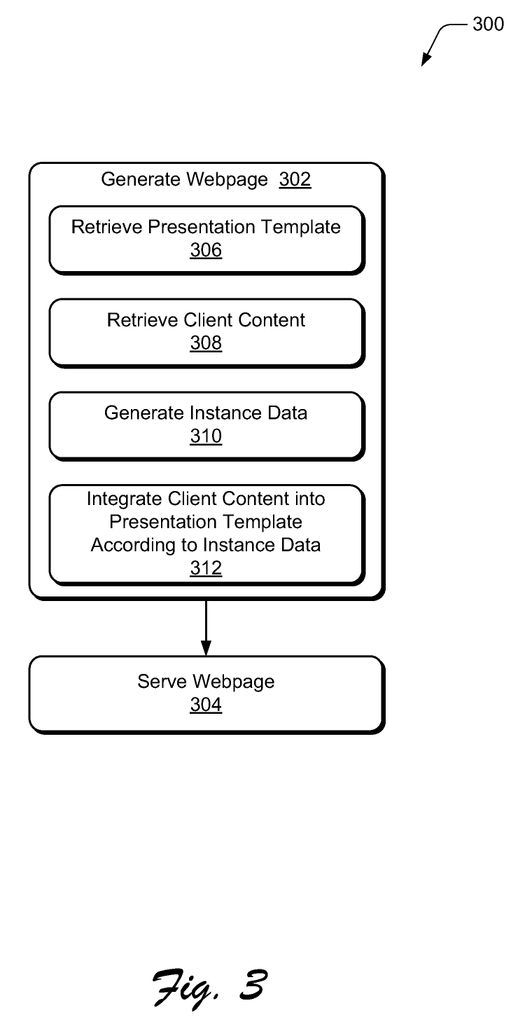

FIG. 3 illustrates a procedure 300 in an example implementation in which server-side techniques are used to deliver client content on a webpage by a server such as the server 102 of FIG. 1. As illustrated, a webpage is generated for a client (block 302) so that the webpage may be served (block 304) when a request for the webpage is received from a client. For example, a website, such as a social networking website, may allow a client to create a personalized storytelling webpage to share client content with other clients of the website. The client may access (e.g., register or login to) the website, whereupon the client is presented with configuration options for construction of the client's webpage and prompted to select customized features of the webpage. HTML is generated describing the webpage, and may be served over a network to furnish access to the webpage.

A presentation template is retrieved (block 306). For example, in the storytelling webpage embodiment discussed above, the client may be prompted to select a presentation template from a selection of presentation templates presented to the client by the website. The presentation templates may be created by one or more design entities (e.g., designers) and stored in memory of the server for the website (e.g., server 102 of FIG. 1) using the example meta-language described in relation to FIG. 2.

Client content is also retrieved (block 308). For example, in the storytelling webpage embodiment, the client may upload desired client content such as photographs, text, videos, audio, drawings, graphics, blogs, links, and so forth that are related to the story being presented by the webpage. As noted above, client content may also be retrieved from sources other than the client 104, such as from other websites, from another client, and so forth. Thus, for example, a photograph or text describing a place visited in the story may be retrieved from another website, e.g., a photograph of a casino may be obtained from commercial website hosted by the casino's owners for inclusion in a story about a vacation to Las Vegas.

Instance data is generated (block 310). The instance data may define the integration of the client content into the presentation template to configure HTML describing the webpage being generated. The client content is then integrated into the presentation template as specified by the instance data (block 312). For example, in the storytelling webpage embodiment, the instance data may contain information about the presentation template to be used for the story and the client content that is to be inserted within the presentation template. In implementations, the instance data may be cleared and regenerated if the client content, presentation template, or presentation of the client content within the presentation template is changed, such as when the client decides to select a different presentation template, or include different content.

Example Webpages

This section presents elements of example webpages that may be generated using the processes and techniques discussed herein to provide a chromeless user experience. Aspects of the user interface may be generated in hardware, firmware, software or a combination thereof. In portions of the following discussion, reference will be made to the environment 100 of FIG. 1, the integration 200 of FIG. 2, and the procedure 300 of FIGS. 3, respectively, and/or other example environments, implementations, and procedures.

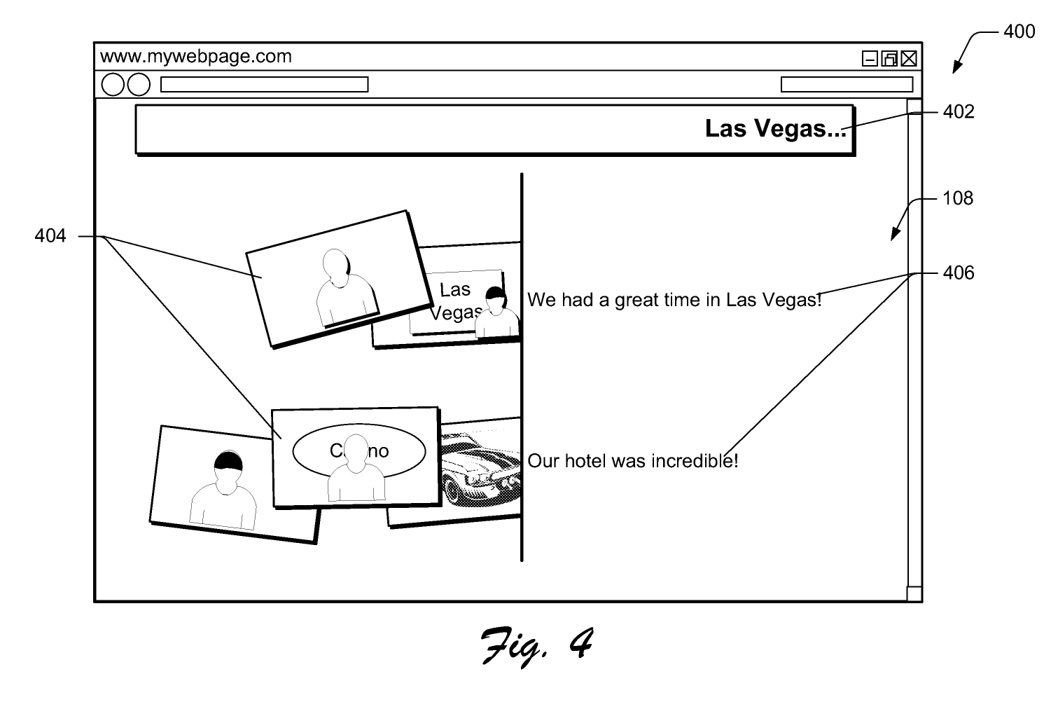

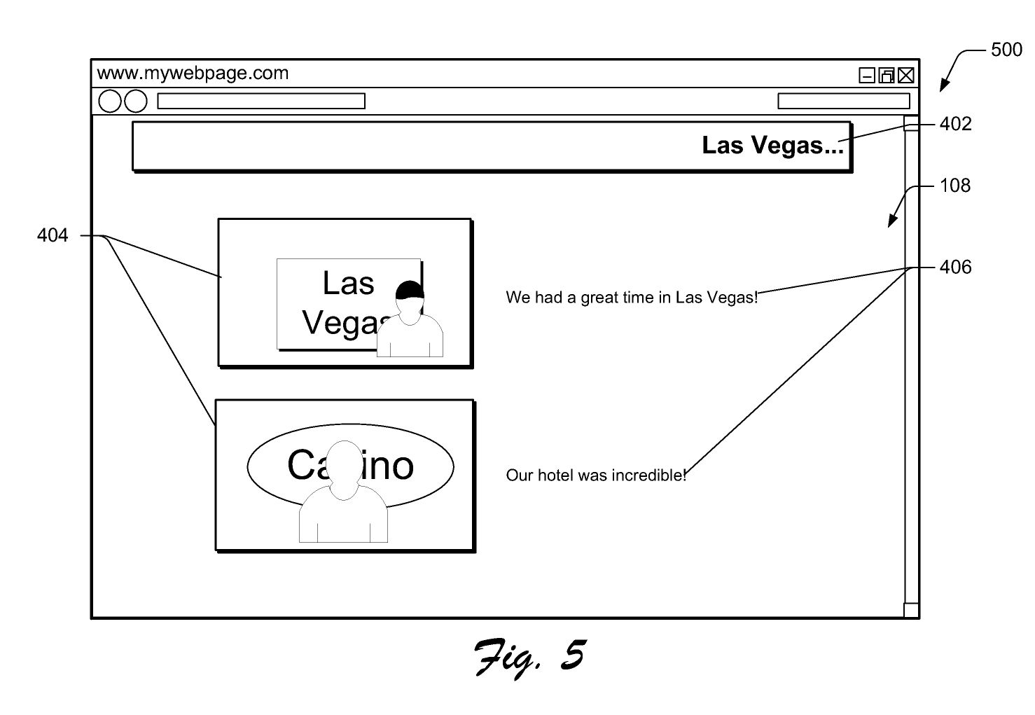

FIGS. 4 and 5 depict example displays 400 & 500 of webpages 108 that may be generated using the procedure 300 shown in FIG. 3. Client content such as a title (e.g., “Las Vegas”) 402, photographs 404 and text 406, is illustrated as being integrated into a presentation template furnishing the theme and layout of the webpage 108. The presentation of the client content and/or the content itself may be customized (e.g., by modifying themes, layouts, applying digital imaging effects to client photographs, and so forth) on the server side to make the webpage 108 aesthetically pleasing to clients who access the webpage 108.

The client for whom the webpage 108 is created may switch between presentations, e.g., colors, styles, themes, layouts, customizations to client content, and so forth by selecting different presentation templates. In implementations, some client content may not be used depending on the presentation template selected. For example, as illustrated in FIGS. 4 and 5, the webpage 108 may utilize less of the client content (e.g., fewer photographs 404 as shown in FIG. 5 as compared to FIG. 4) depending on the presentation template selected by the client.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A computer-implemented method comprising:
retrieving content to be presented in a webpage to be served to a client;
retrieving a presentation template including at least one server-side tag configured to specify a presentation of the content in the webpage; and
integrating the content with the presentation template as specified by the at least one server-side tag to generate the webpage.

2. A computer-implemented method as recited in claim 1, further comprising generating instance data that specifies the integration of the content into the presentation template to configure the webpage.

3. A computer-implemented method as recited in claim 2, wherein the presentation template is generated using a meta-language comprising hypertext markup language (HTML) configured to implement the at least one server-side tag, the at least one server-side tag representing the content in the hypertext markup language (HTML) of the presentation template.

4. A computer-implemented method as recited in claim 3, wherein the at least one server-side tag includes a tag type configured to specify a content type represented by the server-side tag and at least one tag attribute configured to specify one or more attributes of the content.

5. A computer-implemented method as recited in claim 1, wherein integrating the content with the presentation template comprises generating hypertext markup language (HTML) describing the webpage.

6. A computer-implemented method as recited in claim 5, further comprising serving hypertext markup language (HTML) over a network to furnish access to the webpage.

7. A computer-implemented method as recited in claim 8, wherein generating the hypertext markup language (HTML) comprises generating at least one of a cascading style sheet (CSS) or JavaScript.

8. A computer-implemented method as recited in claim 1, wherein the content comprises at least one of a title, a photograph, a video, or text.

9. One or more computer-readable media comprising instructions that are executable by a web server to implement an engine configured to generate a webpage to present content received from a client, the engine being configured to integrate the content with a presentation template that includes at least one tag configured to define presentation of the content in the webpage.

10. One or more computer-readable media as recited in claim 9, wherein the engine is further configured to generate instance data that defines the integration of the content into the presentation template to configure the webpage.

11. One or more computer-readable media as recited in claim 10, wherein the presentation template is generated using a meta-language comprising hypertext markup language (HTML) configured to implement the at least one server-side tag, the at least one tag representing the content in the hypertext markup language (HTML) of the presentation template.

12. One or more computer-readable media as recited in claim 11, wherein the at least one tag includes a tag type configured to specify a content type represented by the tag and at least one tag attribute configured to specify one or more attributes of the content.

13. One or more computer-readable media as recited in claim 10, wherein the content is integrated with the presentation template that comprises hypertext markup language (HTML) describing the webpage.

14. One or more computer-readable media as recited in claim 9, wherein the engine is further configured to serve the hypertext markup language (HTML) file over a network to furnish access to the webpage.

15. One or more computer-readable media as recited in claim 9, wherein the webpage includes at least one of a cascading style sheet (CSS) or JavaScript.

16. One or more computer-readable media as recited in claim 9, wherein the content comprises at least one of a photograph, a video, or text.

17. One or more computer-readable media comprising instructions that are executable by a web server to implement an engine configured to:
retrieve client content received from a client over a network to be presented in a webpage;
retrieve a presentation template that defines presentation of the client content, the presentation template being generated using a meta language including at least one tag configured to define the presentation of the client content in the webpage;
generate instance data that defines integration of the client content into the presentation template to configure hypertext markup language (HTML) describing the webpage; and
serve the hypertext markup language (HTML) over a network to furnish access to the webpage.

18. One or more computer-readable media as cited in claim 17, wherein the meta-language comprises hypertext markup language (HTML) configured to implement the at least one tag, the at least one tag represents the content in the hypertext markup language (HTML) of the presentation template.

19. One or more computer-readable media as cited in claim 17, wherein the at least one tag includes a tag type configured to specify a content type represented by the tag and at least one tag attribute configured to specify one or more attributes of the client content.

20. One or more computer-readable media as recited in claim 17, wherein the hypertext markup language (HTML) comprises at least one of a cascading style sheet (CSS) or JavaScript.
